(19) United States
(12) Patent Application Publication
(10) Pub. No.: US 2025/0348890 A1
(43) Pub. Date: Nov. 13, 2025

(54) System and method for automated auditing, pricing validation and consumer protection in automotive finance transactions

(71) Applicant: Dylan Christopher Herlehy, houston, TX (US)

(72) Inventor: Dylan Christopher Herlehy, houston, TX (US)

(21) Appl. No.: 19/276,746

(22) Filed: Jul. 22, 2025

(51) Int. Cl. G06Q 30/018; G06Q 40/08; G06Q 40/12; G06V 30/413

(52) U.S. Cl. CPC G06Q 30/018; G06Q 40/082; G06Q 40/124; G06V 30/413

(57) ABSTRACT

SmartBuyer AI is an automated quote analysis and scoring system for current or previous vehicle purchases. The system accepts car deal quote images or data inputs, extracts product and pricing details, and audits these against a rule-based engine. It generates a SmartBuyer Score (0-100) and a detailed PDF report flagging overpriced or missing items such as GAP insurance, vehicle service contracts, maintenance plans, and add-ons. The system provides real-time consumer education and optional challenge-based incentives to promote fair and transparent automotive transactions.

A modular AI-based system for analyzing, auditing, and scoring vehicle purchase quotes in real-time. The system accepts consumer-uploaded quote images or structured deal data, uses optical character recognition (OCR) to extract relevant terms (e.g. MSRP, vehicle type, term length, loan details, and aftermarket products), and applies a rule-based engine to evaluate fairness thresholds for products such as GAP insurance, Vehicle Service Contracts (VSC), maintenance plans, and dealership add-ons. Based on the extracted data, the system generates a SmartBuyer Score indicating quote fairness and a Dealer Trust Score for participating dealerships. The system can output reports with product-specific audits, identify missing protections, apply price caps based on dynamic variables (vehicle class, term, mileage), and recommend improvements. A user-facing interface includes real-time negotiation support, translation modules, and upgrade prompts. Administrative controls allow for manual override, fraud detection, and audit history monitoring.

### FIELD OF THE INVENTION

The present invention relates generally to systems and methods for analyzing automotive purchase quotes. and more particularly to a modular. AI-assisted platform that performs fairness audits, product evaluations, and scoring functions based on consumer-uploaded deal data. The invention is situated within the fields of financial technology (FinTech), automotive sales systems, and AI-driven consumer protection tools.

### BACKGROUND OF THE INVENTION

In the process of purchasing a new or used vehicle. consumers are commonly presented with a quote or “pencil” that includes various financial terms and optional products such as GAP insurance. Vehicle Service Contracts (VSC), maintenance plans, and aftermarket add-ons. These quotes are often complex. inconsistent in structure, and difficult for the average buyer to evaluate fairly. Many buyers lack the technical knowledge or market insight required to determine whether a quote is priced reasonably or includes unnecessary or overpriced items. Dealerships may generate significant backend profit by bundling or inflating the prices of these products. and buyers are frequently unaware of industry norms, acceptable pricing ranges, or the impact of such products on loan structure and long-term cost. Existing solutions—such as online articles, generic financial tools, or AI chatbots—do not provide structured quote audits, rule-based price fairness evaluations, or product-specific scoring logic.

There exists a need for a system that can automatically analyze vehicle purchase quotes, extract relevant data, and assess fairness using transparent and configurable audit logic. Such a system would empower consumers to make informed decisions, hold dealerships accountable to ethical standards, and enhance transparency in the automotive finance process. The present invention addresses these shortcomings through a modular, AI-enhanced platform that evaluates deal quotes in real time and outputs customized reports, fairness scores, and dealer trust metrics.

### SUMMARY OF THE INVENTION

The present invention is a modular, AI-driven system designed to evaluate vehicle purchase quotes for fairness, transparency, and adherence to defined industry norms. It provides consumers with an automated method of uploading vehicle purchase quotes—whether in the form of scanned documents, digital images, or structured data-and receiving an audit report containing itemized feedback, product-specific fairness evaluations, and an overall quote score. At its core, the system consists of several integrated components:

Input Processing Module: This module accepts uploaded deal quote images or digital documents and uses Optical Character Recognition (OCR) to extract structured data such as VIN, MSRP, vehicle year/make/model, finance terms, monthly payment, and itemized products (e.g., GAP insurance, Vehicle Service Contracts (VSC), maintenance plans, add-ons).

Audit Engine: This rule-based module applies a series of logic-driven evaluations based on thresholds that may vary by vehicle type, price, loan term, and product category. The audit engine checks for overpricing, bundling, omission of needed protections, and abusive add-ons, referencing both static price caps and dynamic variables.

Scoring System: The system generates a SmartBuyer Score (0-100 scale) to represent overall deal fairness. The score is adjusted in real-time based on audit outcomes across product categories and pricing thresholds. It may apply deductions for excessive product pricing, missing protections when warranted, or bundled lines that obscure deal terms.

Dealer Trust Score Module: For dealerships enrolled in the platform, each uploaded quote impacts their live Trust Score. Quotes that meet ethical standards or pass fairness audits may improve the score, while excessive pricing or repeated violations reduce it.

Output & User Interface: The system generates a PDF audit report for the user, highlighting flagged items, recommended actions, and buyer education. It also powers an AI-driven assistant for live support, multilingual translation, and product explanations.

Administrative Controls: An internal admin portal allows for score overrides, abuse flagging, quote duplication detection, and audit history review. All audit data is stripped of (PII) after processing, except for key deal elements retained for user report access and dealer performance tracking.

The invention empowers consumers by giving them immediate, personalized insight into their automotive purchase quotes, promotes ethical sales practices among dealerships, and facilitates a feedback-driven trust ecosystem within the automotive retail industry.

### DETAILED DESCRIPTION OF THE INVENTION

The following is a comprehensive description of the systems, components, processes, and functionalities that comprise the invention titled “Automated Quote Analysis and Scoring System for Vehicle Purchases.” This system, referred to herein as “SmartBuyer AI.” is a modular and rules-driven platform that leverages artificial intelligence, rule-based logic, and data extraction technology to perform fairness evaluations on automobile purchase quotes.

### Overview

SmartBuyer AI is designed to ingest consumer-submitted vehicle purchase quotes in various formats, extract key financial and product data, evaluate that data against a set of pricing rules and ethical standards, and generate a user-facing audit report with scoring outcomes and recommendations. The invention includes both consumer-facing and administrator-facing interfaces, and may optionally integrate with dealership systems, third-party APIs (e.g., VIN decoders), and language translation models.

### Input System and Data Acquisition

The system begins with the user uploading a document via the SmartBuyer Al interface. Acceptable formats include: PDF documents, JPG or PNG images (e.g., smartphone photos of a printed quote), and structured form entries. Upon upload, the document is processed by an OCR module which converts visual data into machine-readable text. Key data extracted includes VIN, MSRP, selling price, loan term, APR, monthly payment, product line items (GAP, VSC, etc.), dealer name and location, and deal type (finance, lease, or cash).

### Audit Engine

The Audit Engine applies pre-defined rules and thresholds to the extracted data. It performs the following evaluations:
GAP Audit: Capped at the lower of $1,200 or 3% of MSRP; $1,500 allowed if MSRP≥$60,000.
VSC Audit: MSRP≤$45,000→ New: 15% or $4,000, Used: 16% or $6,000; MSRP>$45,000→New 15%, Used: 16%.
Maintenance Plan Audit: Capped at $1,500.
Add-On Product Audit: Total not to exceed $1,000.
Bundled Line Detection: Deductions applied for lack of transparency.

### Scoring System

The SmartBuyer Score (0-100 scale) is derived from audit outcomes. Deductions include:—GAP overpricing: -10 pts
VSC overpricing: -10 pts
Add-ons excess: -5 pts
Bundling: -10 pts
Missing protections: -5 to -10 pts

### Dealer Trust Score Module

Participating dealers receive dynamic Trust Scores based on quote quality. Scores increase with fair quotes and decrease with violations. Duplicate quote submissions are excluded via hash detection.

### Audit Output and Report Generation

Each audit generates a PDF report with itemized evaluations, flags, and recommendations. All reports include a watermark: “For informational purposes only. SmartBuyer AI is not a lender or broker.”

### User Interface and AI Integration

An AI assistant guides users through audit interpretation, negotiation tips (on premium tiers), and multilingual support. It also facilitates upgrade offers and Verified Dealer routing if no vehicle has been selected.

### Administrative & Security Controls

The system includes a secured administrative portal that enables internal SmartBuyer AI team members to perform score overrides under special review, flag and track suspected abuse patterns, and investigate duplicate quote uploads. The portal includes access to quote audit history, admin notes, and system logs. Personally Identifiable Information (PII) is automatically stripped after audit processing, with only the deal structure data retained for dealer scoring, report generation, and internal quality control.

### CLAIMS

### Claim 1 (Independent Claim)

A computer-implemented system for analyzing vehicle purchase quotes, comprising: a. an input module configured to receive vehicle purchase quote data, including at least one of scanned images, PDFs, or structured digital inputs; b. an optical character recognition (OCR) module configured to extract structured data from said input, including vehicle identification number (VIN), MSRP, loan terms, product line items, and dealership identifiers; c. an audit engine configured to evaluate the extracted data using a set of predefined rules based on product category, MSRP, loan duration, and buyer profile; d. a scoring module configured to compute a consumer-facing quote fairness score and a dealer-facing trust score based on outcomes of said audit; e. an output generator configured to produce a human-readable audit report containing product-level evaluations, flags, and recommendations; f. a secure backend configured to manage user data, enforce deletion of input media after processing, and store audit result metadata; wherein the system provides transparency and fairness assessments for automotive purchase quotes.

### Claim 2

The system of claim 1, wherein the audit engine includes pricing caps for GAP insurance set at the lower of $1,200 or 3% of MSRP, with a $1,500 cap for MSRP values≥$60,000.

### Claim 3

The system of claim 1, wherein the audit engine includes pricing caps for Vehicle Service Contracts (VSC) as follows: MSRP≤$45,000: capped at the lesser of 15% MSRP or $4,000 for new vehicles, and 16% MSRP or $6,000 for used vehicles; MSRP >$45,000: capped at 15% MSRP for new vehicles and 16% MSRP for used vehicles.

### Claim 4

The system of claim 1, wherein the audit engine flags product bundling when two or more aftermarket items are combined into a single line item without itemized pricing.

### Claim 5

The system of claim 1, wherein the scoring module deducts points from the SmartBuyer Score for rule violations including overpricing, bundling, or omission of required products.

### Claim 6

The system of claim 1, wherein the dealer trust score is computed based on aggregated quote audit outcomes, excluding duplicate submissions identified by quote hash or VIN matching.

### Claim 7

The system of claim 1, wherein the output generator includes a disclaimer watermark stating, “For informational purposes only. SmartBuyer AI is not a lender or broker.”

### Claim 8

The system of claim 1, wherein the user interface includes an AI-powered assistant capable of interpreting audit results, providing negotiation suggestions, and supporting multilingual translation.

### Claim 9

The system of claim 1, wherein after audit completion, the user is redirected to either share the report with a dealership or upgrade their experience tier.

### Claim 10

The system of claim 1, further comprising an administrative backend interface enabling manual overrides, fraud flagging, audit history access, and abuse detection.

### Claim 11

A computer-implemented method for generating a fairness score for an automotive purchase quote, the method comprising:
receiving a digital quote containing one or more finance or product line items;
identifying product categories such as GAP insurance, vehicle service contracts (VSCs), maintenance plans, and dealer add-ons;
validating the pricing and presence of each category based on vehicle type, loan term, MSRP, and buyer profile;
calculating individual sub-scores for each product category based on pricing thresholds and ethical deal structure standards; and outputting a composite SmartBuyer Score for the quote, wherein the score influences a dealer trust metric and user report.

### DRAWINGS

The following figures provide illustrative support for the structural and functional components of the disclosed invention. Each diagram is described in detail to demonstrate the relationship between modules and the logical progression of the system's operation.

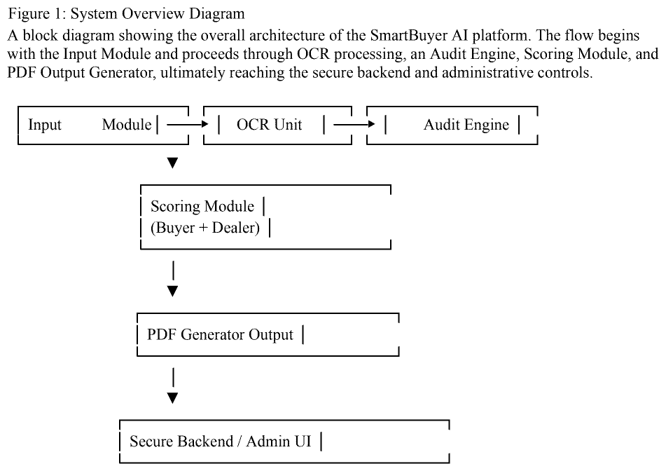

### FIG. 1: System Overview Diagram

A block diagram showing the overall architecture of the SmartBuyer AI platform. The flow begins with the Input Module and proceeds through OCR processing, an Audit Engine, Scoring Module, and PDF Output Generator, ultimately reaching the secure backend and administrative controls.

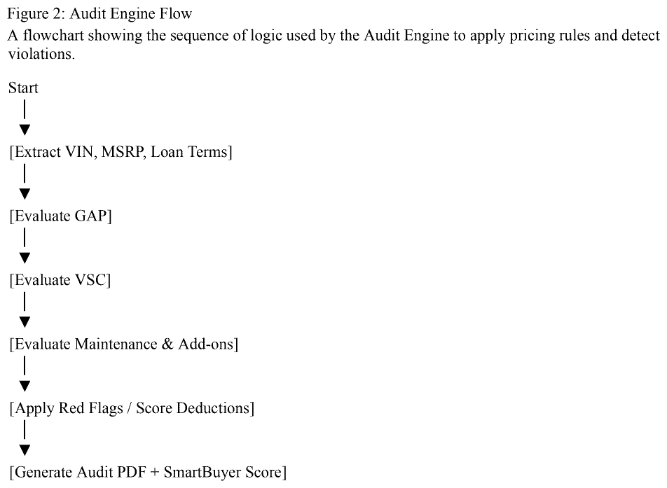

### FIG. 2: Audit Engine Flow

A flowchart showing the sequence of logic used by the Audit Engine to apply pricing rules and detect violations.

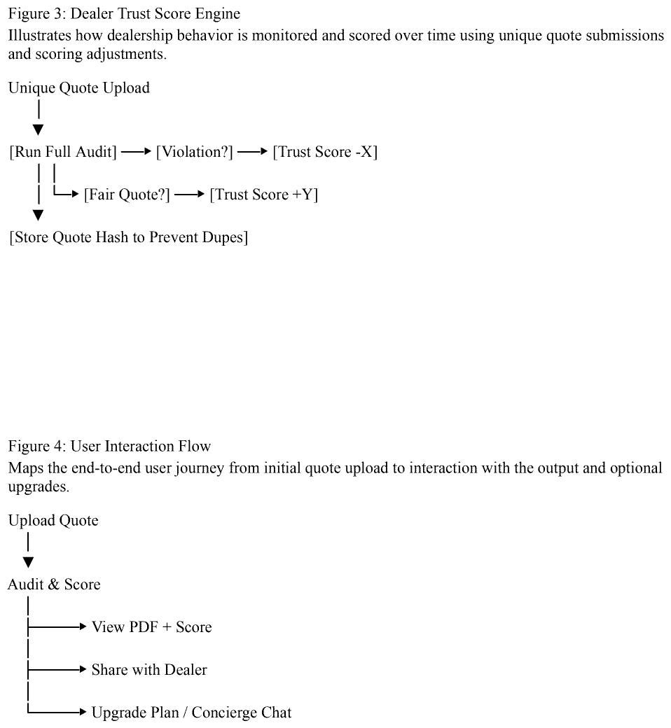

### FIG. 3: Dealer Trust Score Engine

Illustrates how dealership behavior is monitored and scored over time using unique quote submissions and scoring adjustments.

### FIG. 4: User Interaction Flow

Maps the end-to-end user journey from initial quote upload to interaction with the output and optional upgrades.

1. A computer-implemented method comprising:
(a) receiving an image or document of a vehicle purchase quote;
(b) extracting structured data from the quote using optical character recognition (OCR);
(c) identifying and classifying line items including GAP insurance, vehicle service contracts (VSC), maintenance plans, dealer add-ons, fees, and finance-related incentives;
(d) applying one or more audit rules to detect pricing anomalies, omissions, or bundled products based on MSRP, mileage, loan term, and predefined thresholds;
(e) generating a numerical scoring metric ('SmartBuyer Score') representing deal fairness based on audit results;
(f) producing a downloadable PDF audit report containing the SmartBuyer Score, visual indicators, and rule-based flags;
(g) optionally enrolling the user into a competitive incentive program based on score ranking or quote fairness.

2. The method of claim 1, wherein GAP insurance pricing is evaluated against a cap defined as the lesser of a fixed dollar amount or a percentage of the vehicle MSRP.

3. The method of claim 1, wherein the presence of a finance certificate triggers an advisory flag if the financing condition negates eligibility for lease or cash incentives.

4. The method of claim 1, further comprising a badge generation system displaying the user's SmartBuyer Score for public or social media sharing.

5. The method of claim 1, wherein all audit engine logic is executed on a secure server and is protected from manipulation by frontend clients or external users.

6. The method of claim 1, wherein quote uploads are rate-limited and fingerprinted to prevent duplication or submission-based abuse.

7. The method of claim 1, wherein audit results are used to dynamically adjust a Dealer Trust Score displayed publicly, impacting dealer verification eligibility.

8. The method of claim 1, further comprising auto-deleting uploaded quote data after audit generation, while retaining extracted metadata for scoring analytics and trust evaluations.

9. The method of claim 1, wherein the SmartBuyer Score is displayed in a public-facing badge or leaderboard format as part of a competitive consumer challenge program.

10. The method of claim 1, wherein the audit results and scoring report are delivered through a multilingual user interface, enabling translation of audit explanations, product definitions, and recommendations into the user's preferred language, with support for real-time or Ai-generated translations.

11. The method of claim 1, further comprising logic that, based on audit score results, routes to a list of verified dealerships or offers alternative options from participating Verified dealers, using Smartbuyer Score thresholds to trigger eligibility

12. The method of claim 1, further comprising a fingerprinting mechanism for uploaded quotes that detects repeated or modified submissions by the same user, using metadata, hash comparisons, and submission patterns to flag potential abuse or manipulation of the scoring system.

13. The method of claim 1, wherein scoring thresholds are dynamically adjusted based on vin-specific data, regional msrp variations, or localized incentive programs, enabling personalized audit logic that reflects real-time market conditions or dealer geography.

14. A system for analyzing vehicle purchase quotes, comprising: an OCR engine, an audit rules module, a scoring engine, a report generation module, and a user interface for receiving quote uploads and delivering downloadable audit reports containing scoring results.
